(19) United States
(12) Patent Application Publication
(10) Pub. No.: US 2024/0037185 A1
(43) Pub. Date: Feb. 1, 2024

(54) INCONSISTENCY DETERMINATION DEVICE, METHOD, AND COMPUTER-READABLE RECORDING MEDIUM

(71) Applicant: NEC Corporation, Minato-ku, Tokyo (JP)

(72) Inventors: Fumiyo TAKANO, Tokyo (JP); Hiroaki INOUE, Tokyo (JP); Takuya ARAKI, Tokyo (JP); Motoi SUZUKI, Tokyo (JP); Yuki KOBAYASHI, Tokyo (JP); Takahiro NISHIMURA, Tokyo (JP); Hiroshi CHISHIMA, Tokyo (JP); Akihiro YATABE, Tokyo (JP)

(73) Assignee: NEC Corporation, Minato-ku, Tokyo (JP)

(21) Appl. No.: 18/011,329

(22) PCT Filed: Jun. 29, 2020
(86) PCT No.: PCT/JP2020/025539

§ 371 Date: Dec. 19, 2022

(51) Int. Cl. G06F 17/18

(52) U.S. Cl. CPC G06F 17/18

(57) ABSTRACT

The inconsistency determination device 1 includes inconsistency determination means 9. The inconsistency determination means 9 determines whether or not there is inconsistency in an expression, which is to be converted into an energy function of a model representing states of individual spins by a first value or a second value, representing energy in a combinatorial optimization problem.

### TECHNICAL FIELD

The present invention relates to an inconsistency determination device, an inconsistency determination method, and a computer-readable recording medium in which an inconsistency determination program is recorded, that determine whether or not there is in an expression representing energy in a combinatorial optimization problem.

### BACKGROUND ART

PTL 1 describes solving a combinatorial optimization problem by simulated annealing.

With the practical application of quantum annealing machines, solving combinatorial optimization problems is becoming more common. Examples of combinatorial optimization problems are the traveling salesman problem, the knapsack problem, and the graph partitioning problem. However, the combinatorial optimization problem is not limited to these problems.

An energy function of the Ising model or QUBO (Quadratic Unconstrained Binary Optimization) is input to a computer which solves a combinatorial optimization problem with simulated annealing or quantum annealing.

The Ising model is a model in statistical mechanics that represents the behavior of a magnetic material by individual spins, and it is also applicable to solving combinatorial optimization problems. In the Ising model, the states of individual spins are represented by “1” or “−1”.

QUBO is also known as a model in which the states of individual spins are represented by “1” or “0”.

Note that “1” in the Ising model and “1” in QUBO can be referred to as the first value, and, “−1” in the Ising model and “0” in QUBO can be referred to as the second value.

The energy function of the Ising model and the energy function of QUBO are mutually convertible.

In the current situation, the solution of the combinatorial optimization problem is obtained by simulated annealing using a general computer mainly with the energy function of the Ising model or of QUBO as input. An example of this method is described below. Here, the case of finding a solution to the traveling salesman problem is took as an example.

First, an expression that represents the energy in the traveling salesman problem is generated. The generation of the expression representing energy in the combinatorial optimization problem may be referred to as formulation. An example of the expression obtained by the formulation of the traveling salesman problem is Expression (1) shown below.

$$\begin{matrix}[ Math . 1 ] & \\ H = α {{\sum }_{v = 1}}^{n} {( 1 - {{\sum }_{j = 1}}^{N} {x}_{v , j} )}^{2} + α {{\sum }_{j = 1}}^{n} {( 1 - {{\sum }_{v = 1}}^{N} {x}_{v , j} )}^{2} + β {\sum }_{( uv ) ∈ E} {W}_{uv} {{\sum }_{j = 1}}^{N} {x}_{u , j} {x}_{v , j + 1} & ( 1 )\end{matrix}$$

In Expression (1), j represents a time, and v and u represent cities. Also, x_{v,j} is a variable that represents whether or not the salesman is in city v at the time j, and corresponds to the spin. x_{v,j}=1 means that the salesman is in the city v at the time j, and x_{v,j}=0 means that the salesman is not in the city v at the time j. In Expression (1), Wᵤᵥ is a distance between cities u and v, which is predetermined as a constant for each pair of cities. α and β are predetermined as constants.

The first term on the right-hand side in Expression (1) represents a constraint that the salesman can never pass through the same city two times or more.

The second term on the right-hand side in Expression (1) represents a constraint that the salesman is present in only one city at one time.

The third term on the right-hand side in Expression (1) represents a distance between the cities through which the salesman passes. The third term on the right-hand side is not a term representing a constraint. On the other hand, the third term on the right-hand side is the term that represents the matter whose value is to be minimized for the user who wants to obtain the solution to the traveling salesman problem. Thus, the term that does not represent a constraint and represents the matter whose value is to be minimized for the user who wants to obtain the solution to the combinatorial optimization problem is referred to as an objective function. In other words, the third term on the right-hand side in Expression (1) is the objective function.

Once the expression representing energy in the combinatorial optimization problem as exemplified in Expression (1) has been generated, the expression is converted to the energy function of the Ising model or the energy function of QUBO. This conversion method is known.

The energy function of the Ising model is expressed as the following Expression (2).

$$\begin{matrix}[ Math . 2 ] & \\ {H}_{Ising} = {\sum }_{i j} {J}_{i {j}^{S} {i}^{S} j} + {\sum }_{i} {h}_{i} {s}_{i} & ( 2 )\end{matrix}$$

In Expression (2), sᵢ, sⱼ are variables that represent a state of a spin. The subscripts in these variables identify the spins. Jᵢⱼ is a constant related to i and j, and hᵢ is a constant related to i.

The energy function of QUBO is expressed as the following Expression (3).

$$\begin{matrix}[ Math . 3 ] & \\ {H}_{Q U B O} = {\sum }_{i j} {Q}_{i j} {x}_{i} {x}_{j} & ( 3 )\end{matrix}$$

In Expression (3), xᵢ, xⱼ are variables that represent a state of a spin. The subscripts in these variables identify the spins. Qᵢⱼ is a constant related to i and j.

Expression (2) and Expression (3) are second-order expressions of the variables that represent the states of spins. Expression (1) is also a second-order expression of the variables that represent the states of spins. Therefore, Expression (1) can be converted to Expression (2) or Expression (3).

Even if the order of the variables representing the states of spins in the expression obtained by the formulation is the third order or higher, the order of the variables representing the states of spins can be reduced to the second order, by replacing a plurality of the variables representing the states of spins with a single variable. The variable used in the above replacement is referred to as the auxiliary variable. Therefore, even if the order of the variables representing the states of spins in the expression obtained by the formulation is the third or higher, the energy function of the Ising model (Expression (2)) or the energy function of QUBO (Expression (3)) can be obtained by using the auxiliary variable.

Once the energy function of the Ising model or QUBO is obtained, the energy function is applied to simulated annealing to identify the state of each spin when the energy is minimized. Then, the optimal solution is obtained by interpreting the state of each spin according to the combinatorial optimization problem (in this example, the traveling salesman problem).

NPL 1 describes how various constraints are expressed in a formulated expression (an expression representing energy in a combinatorial optimization problem) that is converted into the energy function of QUBO.

### CITATION LIST

### Patent Literature

PTL 1: Japanese Patent Application Laid-Open No. H10-293756

### Non Patent Literature

NPL 1: Fred Glover, Gary Kochenberger, Yu Du, “Quantum Bridge Analytics I: A Tutorial on Formulating and Using QUBO Models”, [retrieved on Jun. 3, 2020], Internet <URL : https://arxiv.org/ftp/arxiv/papers/1811/1811.11538.pdf>

### SUMMARY OF INVENTION

### Technical Problem

Even if there is inconsistency in the expression formulated by the user (the expression representing energy in the combinatorial optimization problem), the expression can be converted to the energy function of the Ising model or the energy function of QUBO. Then, by performing annealing on the energy function, a solution to the combinatorial optimization problem can be obtained.

However, there is a case in which the solution to the combinatorial optimization problem is not appropriate. Even if the user can determine that the solution to the combinatorial optimization problem is not appropriate, it is difficult for the user to specify the cause. Since annealing is a stochastic process, it is possible that an inappropriate solution may be derived even if the input energy function is appropriate. An inappropriate solution may also be derived due to inconsistency in the expression formulated by the user, as described above.

Therefore, it is desirable to be able to determine whether or not there is inconsistency in the formulated expression (the expression representing energy in a combinatorial optimization problem).

Therefore, an object of the present invention is to provide an inconsistency determination device, an inconsistency determination method, and a computer-readable recording medium in which an inconsistency determination program is recorded, that can determine whether or not there is inconsistency in the expression representing energy in a combinatorial optimization problem.

### Solution to Problem

An inconsistency determination device according to the present invention includes: inconsistency determination means for determining whether or not there is inconsistency in an expression, which is to be converted into an energy function of a model representing states of individual spins by a first value or a second value, representing energy in a combinatorial optimization problem.

An inconsistency determination method according to the present invention is implemented by a computer, and includes: determining whether or not there is inconsistency in an expression, which is to be converted into an energy function of a model representing states of individual spins by a first value or a second value, representing energy in a combinatorial optimization problem.

A computer-readable recording medium according to the present invention is a computer-readable recording medium in which an inconsistency determination program is recorded, wherein the inconsistency determination program causes a computer to execute: an inconsistency determination process of determining whether or not there is inconsistency in an expression, which is to be converted into an energy function of a model representing states of individual spins by a first value or a second value, representing energy in a combinatorial optimization problem.

### Advantageous Effects of Invention

According to the present invention, it is possible to determine whether or not there is inconsistency in the expression representing energy in a combinatorial optimization problem.

### BRIEF DESCRIPTION OF DRAWINGS

FIG. 1 It depicts a block diagram showing an example configuration of an inconsistency determination device of the first example embodiment of the present invention.

FIG. 2 It depicts a flowchart showing an example of the processing flow of the first example embodiment.

FIG. 3 It depicts a flowchart showing an example of the processing flow of the second example embodiment.

FIG. 4 It depicts a block diagram showing an example configuration of an inconsistency determination device of the third example embodiment of the present invention.

FIG. 5 It depicts a diagram showing an example of a character string defining each variable representing state of spin.

FIG. 6 It depicts a flowchart showing an example of the processing flow of the third example embodiment.

FIG. 7 It depicts a schematic block diagram showing an example of computer configuration related to the inconsistency determination device of each example embodiment of the present invention.

FIG. 8 It depicts a block diagram showing an overview of the inconsistency determination device of the present invention.

### DESCRIPTION OF EMBODIMENTS

Example embodiments of the present invention is described below with reference to the drawings.

In each of the following example embodiment, the case will be used in which a formulated expression (an expression representing energy in a combinatorial optimization problem) is converted into the energy function of QUBO. In this case, the variable representing the state of spin takes the value of 1 or 0. However, as discussed below, the invention may also be applied to the case where the formulated expression is converted into the energy function of the Ising model.

### Example Embodiment 1

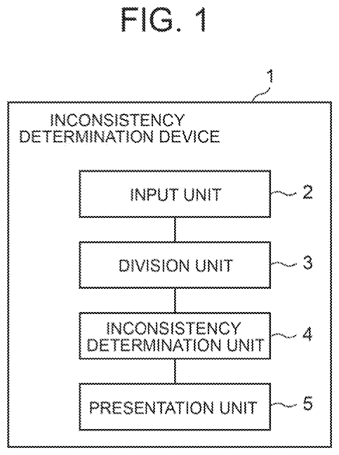

FIG. 1 is a block diagram showing an example configuration of an inconsistency determination device of the first example embodiment of the present invention. The inconsistency determination device 1 of the first example embodiment includes an input unit 2, a division unit 3, an inconsistency determination unit 4, and a presentation unit 5.

A formulated expression (an expression representing energy in a combinatorial optimization problem) is input to the input unit 2.

The input unit 2 may be realized by a data reading device that reads data (in the present example embodiment, the expression representing energy in the combinatorial optimization problem) recorded on a data recording medium such as an optical disk, for example. However, the input unit 2 is not limited to such a data reading device, but may also be an input device such as a keyboard for the user to input the expression.

The division unit 3 takes in the expression (the expression representing energy in the combinatorial optimization problem) via the input unit 2. The division unit 3 then divides the expression into multiple terms.

For example, it is assumed that the following Expression (4) is input to input unit 2.

$$\begin{matrix}[ Math . 4 ] & \\ H = {α ( 1 - {{\sum }_{i = 1}}^{N} {x}_{i} )}^{2} + {β ( 1 - {x}_{1} )}^{2} + {γ ( 1 - {x}_{2} )}^{2} + {{\sum }_{i = 1}}^{N} {c}_{i} {x}_{i} & ( 4 )\end{matrix}$$

In Expression (4), α, β, and γ are constants. In addition, xᵢ, x₁, and x₂ are variables representing the state of spin, and the spins are identified by the subscripts in these variables. In each example embodiment, the variable representing the state of spin takes a value of 1 or 0. In the example in Expression (4), spins are identified by integers from 1 to N. cᵢ is a constant corresponding to i.

When Expression (4) is input, the division unit 3 divides the right-hand side of Expression (4) term by term. This results in

$$\begin{matrix}[ Math . 5 ] & \\ {α ( 1 - {{\sum }_{i = 1}}^{N} {x}_{i} )}^{2} & \end{matrix}$$

and β(1−x₁)² and γ(1−x₂)² and

$$\begin{matrix}[ Math . 6 ] & \\ {{\sum }_{i = 1}}^{N} {c}_{i} {x}_{i} . & \end{matrix}$$

The terms obtained by dividing the expression term by term by the division unit 3 are divided into terms representing constraints and an objective function. A term representing a constraint is hereinafter referred to as the constraint term. In the above example,

$$\begin{matrix}[ Math . 7 ] & \\ {α ( 1 - {{\sum }_{i = 1}}^{N} {x}_{i} )}^{2} & \end{matrix}$$

and β(1−x₁)² and γ(1−x₂)² correspond to the constraint terms.

In addition,

$$\begin{matrix}[ Math . 8 ] & \\ {{\sum }_{i = 1}}^{N} {c}_{i} {x}_{i} & \end{matrix}$$

corresponds to the objective function. As mentioned above, the objective function is a term that does not represent a constraint, but a term that represents the matter whose value is to be minimized for the user who wants to obtain the solution to the combinatorial optimization problem.

In the present example embodiment, two or more constraint terms are assumed to be obtained.

Here, the case will be used where the constraint term is represented as “constant×(Expression A−Expression B)²”. The constraint term of this form represents the constraint that Expression A=Expression B. Here, Expressions A and B may be the variable itself representing the state of spin. Expressions A and B may also be expressions using the variable representing the state of spin. In addition, Expressions A and B may be constants (e.g., “1”, etc.).

When three constraint terms are obtained as above, the first one represents the constraint, Expression (5), shown below.

$$\begin{matrix}[ Math . 9 ] & \\ 1 = {{\sum }_{i = 1}}^{N} {x}_{i} & ( 5 )\end{matrix}$$

In other words, the first constraint term represents the constraint that 1=x₁+x₂+ . . . +x_{N}.

The second constraint term above represents the constraint that 1=x₁.

The third constraint term above represents the constraint that 1=x₂.

The inconsistency determination unit 4 extracts all of the two or more constraint terms from the terms obtained by dividing the expression term by term by the division unit 3, and for each constraint term, specifies the constraint. In the above example, all three constraint terms mentioned above are extracted, and the constraints 1=x₁+x₂+ . . . +x_{N}, 1=x₁ and 1=x₂ are specified for each constraint term.

When there is inconsistency between the specified constraints, the inconsistency determination unit 4 determines that there is inconsistency regarding the constraints in the input expression (the expression representing energy in the combinatorial optimization problem).

When there is no inconsistency between the specified constraints, the inconsistency determination unit 4 determines that there is no inconsistency regarding the constraints in the input expression. The operation in which the inconsistency determination unit 4 determines whether or not

there is inconsistency between the specified constraints is described here. The inconsistency determination unit 4 substitutes an “expression representing a constraint” into another “expression representing a constraint” and determines whether the substitution results in inconsistency or not. The inconsistency determination unit 4 may substitute multiple “expressions representing constraints” into one “expression representing a constraint”. When the substitution of the “expression representing a constraint” into another “expression representing a constraint” results in inconsistency, the inconsistency determination unit 4 determines that there is inconsistency between the constraint corresponding to the “substituted expression” and the constraint corresponding to the “expression accepting substitution”. The inconsistency determination unit 4 determines that the constraints corresponding to expressions other than the “substituted expression” and the “expression accepting substitution” are not related to the inconsistency described above. When there is no inconsistency after substituting, the inconsistency determination unit 4 determines that there is no inconsistency between the constraint corresponding to the “substituted expression” and the constraint corresponding to the “expression accepting substitution”.

More specific explanation is given. It is assumed that the inconsistency determination unit 4 has specified the expressions representing constraints “1=x₁+x₂+ . . . +x_{N}”, “1=x₁” and “1=x₂”. Since “1=x₁” and “1=x₂” can be substituted into “1=x₁+x₂+ . . . x_{N}”, the inconsistency determination unit 4 substitutes “1=x₁” and “1=x₂” into “1=x₁+x₂+ . . . +x_{N}”. Then, “1=1+1+x₃+x₄+ . . . +x_{N}” is obtained, and this expression can be converted to “x₃+x₄+ . . . +x_{N}=−1”. Here, x₃, x₄, . . . , x_{N} all take the value of 1 or 0, thus the possible value of the left-hand side of “x₃+x₄+ . . . +x_{N}=−1” are integers from 0 to N−2, and the value of the left-hand side is never −1. Therefore, the inconsistency determination unit 4 determines the constraints corresponding to the substituted expressions “1=x₁” and “1=x₂” and the constraint corresponding to the expression accepting substitution “1=x₁+x₂+ . . . +x_{N}” are inconsistent with each other. As a result, the inconsistency determination unit 4 determines that there is inconsistency regarding the constraints in the input expression.

The presentation unit 5 displays the determination results by the inconsistency determination unit 4, for example, on a display device (not shown in FIG. 1) provided by the inconsistency determination device 1. For example, in the above case, the presentation unit 5 displays the fact that there is inconsistency between the constraints that are 1=x₁+x₂+ . . . +x_{N}, 1=x₁ and 1=x₂, and that there is inconsistency regarding the constraints in the input expression on the display device. When it is determined that there is no inconsistency regarding the constraints in the input expression, the presentation unit 5 displays the result of the determination on the display device.

Here is another example of inconsistency regarding constraints. It is assumed the following Expression (6) is input.

$$\begin{matrix}[ Math . 10 ] & \\ H = {α ( 1 - {{\sum }_{i = 1}}^{N} {x}_{i} )}^{2} + {β ( 2 - {{\sum }_{i = 1}}^{N} {x}_{i} )}^{2} & ( 6 )\end{matrix}$$

In this case, the division unit 3 obtains the first and second terms on the right-hand side of Expression (6). Since both of these terms are constraint terms, the inconsistency determination unit 4 extracts these two constraint terms. Then, the inconsistency determination unit 4 specifies the constraint 1=x₁+x₂+ . . . +x_{N} from the first term, and specifies the constraint 2=x₁+x₂+ . . . +x_{N} from the second term. Substituting the latter expression into the former expression yields the expression “1=2”, which cannot be established. Therefore, the inconsistency determination unit 4 determines that there is inconsistency between the constrain 1=x₁+x₂+ . . . +x_{N} and the constraint 2=x₁+x₂+ . . . +x_{N}, and determines that there is inconsistency regarding constraints in the input expression. The first term on the right-hand side of Expression (6) represents that only one of the variables x₁ to x_{N} is 1, and the second term on the right-hand side represents that only two of the variables x₁ to x_{N} are 1, so indeed, there is inconsistency regarding constraints.

The division unit 3, the inconsistency determination unit 4, and the presentation unit 5 are realized, for example, by a CPU (Central Processing Unit) of a computer operating according to an inconsistency determination program. In this case, the CPU may read the inconsistency determination program from a program storage medium such as a program storage device of the computer, and operate as the division unit 3, the inconsistency determination unit 4, and the presentation unit 5 according to the inconsistency determination program. This is the same in the second example embodiment described below.

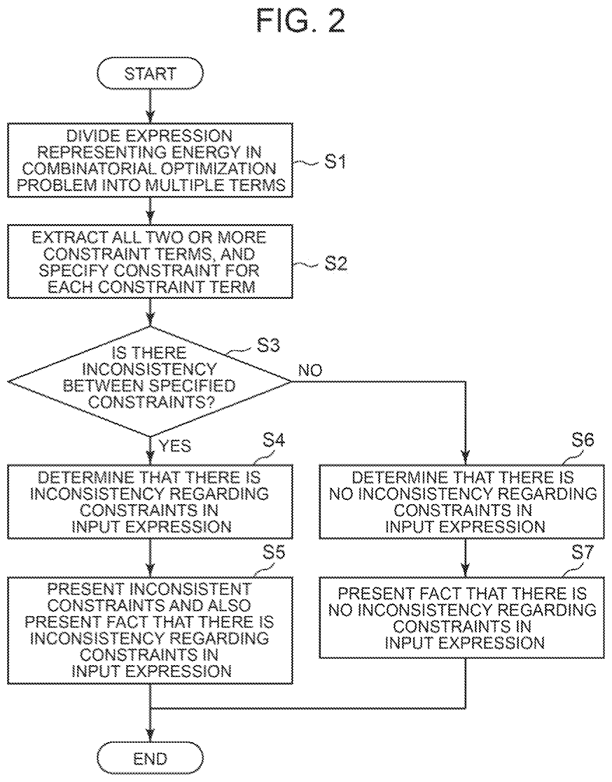

Next, the processing flow is described. FIG. 2 is a flowchart showing an example of the processing flow of the first example embodiment. Matters that have already been explained are omitted as appropriate.

When an expression representing energy in a combinatorial optimization problem is input to the input unit 2, the division unit 3 divides the expression into multiple terms (step S1).

Next, the inconsistency determination unit 4 extracts all two or more constraint terms from each term obtained in step S1, and specifies the constraint for each constraint term (step S2).

Then, the inconsistency determination unit 4 determines whether or not there is inconsistency between the specified constraints (step S3). The inconsistency determination unit 4 may substitute an “expression representing a constraint” into another “expression representing a constraint” and determine whether or not inconsistency occurs as a result of the substitution. When the substitution results in inconsistency, then the inconsistency determination unit 4 may determine that there is inconsistency between the constraint corresponding to the substituted expression and the constraint corresponding to the expression accepting substitution. When no inconsistency occurs as a result of the substitution, then the inconsistency determination unit 4 may determine that there is no inconsistency between the constraint corresponding to the substituted expression and the constraint corresponding to the expression accepting substitution.

When it is determined that there is inconsistency between the specified constraints (Yes in step S3), the inconsistency determination unit 4 determines that there is inconsistency regarding the constraints in the input expression (step S4). In this case, the presentation unit 5 presents the inconsistent constraints and also presents the fact that there is inconsistency regarding the constraints in the input expression (step S5).

When it is determined that there is no inconsistency between the specified constraints (No in step S3), the inconsistency determination unit 4 determines that there is no inconsistency regarding the constraints in the input expression (step S6). In this case, the presentation unit 5 presents the fact that there is no inconsistency regarding the constraints in the input expression (step S7).

The presentation unit 5 may present the information to the user by displaying the information on the display device (not shown in FIG. 1) provided by the inconsistency determination device 1. However, the presentation unit 5 may present the information to the user in other ways. This is the same in other example embodiments.

In the above explanation, the constraint term is expressed as “constant×(Expression A−expression B)²” and this constraint term represents the constraint “Expression A=expression B”. The format of the constraint term is not limited to this format, and the constraint term expressed in various formats may represent the constraint individually.

The various constraint terms and the constraints they represent are shown below. Expressions A, B, and C shown below may be the variable itself representing the state of spin. Expressions A, B, and C shown below may also be expressions using the variable representing the state of spin. In addition, Expressions A, B, and C shown below may be constants (e.g., “1”, etc.).

For example, there may be a constraint term expressed as “constant×(Expression A×Expression B)”. This constraint term represents the constraint “Expression A+Expression B≤1”. In other words, when the inconsistency determination unit 4 extracts the constraint term expressed as “constant×(expression A×expression B)”, the inconsistency determination unit 4 specifies “Expression A+Expression B≤1” as the constraint corresponding to this constraint term.

Also, for example, there may be a constraint term expressed as “constant×(1−Expression A−Expression B+Expression A×Expression B)”. This constraint term represents the constraint “Expression A+Expression B≥1.” In other words, when the inconsistency determination unit 4 extracts the constraint term expressed as “constant×(1−Expression A−Expression B+Expression A×Expression B)”, the inconsistency determination unit 4 specifies the constraint “Expression A+Expression B≥1” as the constraint corresponding to this constraint term.

Also, for example, there may be a constraint term expressed as “constant×(1−Expression A−Expression B+2×Expression A×Expression B)”. This constraint term represents the constraint “Expression A+Expression B=1”. In other words, when the inconsistency determination unit 4 extracts the constraint term expressed as “constant×(1−Expression A−Expression B+2×Expression A×Expression B)”, the inconsistency determination unit 4 specifies “Expression A+Expression B =1” as the constraint corresponding to this constraint term.

For example, there may be a constraint term expressed as “constant×(Expression A−Expression A×Expression B).” This constraint term represents the constraint “Expression A≤Expression B”. In other words, when the inconsistency determination unit 4 extracts the constraint term expressed as “constant×(Expression A−Expression A×Expression B)”, the inconsistency determination unit 4 specifies “Expression A≤Expression B” as the constraint corresponding to this constraint term.

Also, for example, there may be a constraint term expressed as “constant×(Expression A×Expression B+Expression A×Expression C+Expression B×Expression C)”. This constraint term represents the constraint “Expression A+Expression B+Expression C≤1”. In other words, when the inconsistency determination unit 4 extracts the constraint term expressed as “constant×(Expression A×Expression B+Expression A×Expression C+Expression B×Expression C)”, the inconsistency determination unit 4 specifies “Expression A+Expression B+Expression C≤1” as the constraint corresponding to this constraint term.

Also, for example, there may be a constraint term expressed as “constant×(Expression A+Expression B−2×Expression A×Expression B)”. This constraint term represents the constraint “Expression A=Expression B”. In other words, when the inconsistency determination unit 4 extracts the constraint term expressed as “constant×(Expression A+Expression B−2x Expression A×Expression B)”, the inconsistency determination unit 4 specifies “Expression A=Expression B” as the constraint corresponding to this constraint term.

The inconsistency determination unit 4 then determines whether or not there is inconsistency between the specified constraints. As already explained, the inconsistency determination unit 4 may substitute an “expression representing a constraint” into another “expression representing a constraint” and determine whether or not inconsistency occurs as a result of the substitution. When the substitution results in inconsistency, the inconsistency determination unit 4 may determine that there is inconsistency between the constraint corresponding to the substituted expression and the constraint corresponding to the expression accepting substitution. When no inconsistency occurs as a result of the substitution, then the inconsistency determination unit 4 may determine that there is no inconsistency between the constraint corresponding to the substituted expression and the constraint corresponding to the expression accepting substitution.

In the present example embodiment, the inconsistency determination unit 4 specifies a constraint for each constraint term among the terms obtained by dividing the formulated expression. Then, the inconsistency determination unit 4 determines whether or not there is inconsistency among the specified constraints, and when there is inconsistency, the inconsistency determination unit 4 determines that there is inconsistency regarding the constraints in the formulated expression. When there is no inconsistency, the inconsistency determination unit 4 determines that there is no inconsistency regarding the constraints in the formulated expression. Thus, according to the present example embodiment, it is possible to determine whether or not there is inconsistency in the formulated expression.

### Example Embodiment 2

Since the inconsistency determination device of the second example embodiment of the present invention can be represented by the block diagram shown in FIG. 1 in the same way as the inconsistency determination device of the first example embodiment, FIG. 1 is used for the second embodiment described below. Matters similar to those of the first example embodiment will be omitted from the explanation as appropriate.

The input unit 2 and the division unit 3 in the second example embodiment are the same as the input unit 2 and the division unit 3 in the first example embodiment.

The inconsistency determination device 1 of the second example embodiment determines whether or not there is inconsistency regarding an auxiliary variable in the expression representing energy in the combinatorial optimization problem. The auxiliary variable is a variable used to replace variables representing the states of spins in order to lower the order of the variables representing the states of spins to the second order when the order of the variables representing the states of spins is third or higher in the expression obtained by the formulation.

In the second example embodiment, the inconsistency determination unit 4 stores an expression with an auxiliary variable in advance. In the following description, this pre-stored expression is referred to as an pattern expression. In the pattern expression, variables other than the auxiliary variable is variables that represent the states of spins in QUBO. In the pattern expression, the order of the variables representing the states of spins is second order.

An example of a pattern expression is expression (7) shown below.

x₁x₂−2x₁y−2x₂y+x₃y+3y (7)

In expression (7), x₁, x₂, and x₃ are variables that represent the state of spin, and the spins are identified by the subscripts in these variables. Also, y is an auxiliary variable.

Expression (7) is an expression in which y=x₁x₂ in order to lower a third order expression x₁x₂x₃ for the variables representing the state of spin to second order.

When the pattern expression shown in expression (7) exists, then y can be said to be an auxiliary variable. It is also common for an auxiliary variable not to be used outside of expression (7) in expression that encompasses expression (7).

The following is an example of a case in which the inconsistency determination unit 4 stores the pattern expression exemplified in Expression (7) in advance. However, the inconsistency determination unit 4 may store another pattern expression in advance. The inconsistency determination unit 4 may also store multiple pattern expressions.

As in the first example embodiment, the division unit 3 takes in an expression representing energy in a combinatorial optimization problem via the input unit 2. The division unit 3 then divides the expression into multiple terms.

The inconsistency determination unit 4 determines whether or not there is a combination of terms obtained by the division by the division unit 3 that corresponds to the pattern expression stored in advance. When such a combination exists, the inconsistency determination unit 4 specifies the auxiliary variables.

In this example, the inconsistency determination unit 4 stores the pattern expression exemplified in Expression (7) in advance. Therefore, the inconsistency determination unit 4 determines whether or not the combination of five terms corresponding to “x₁x₂”, “−2x₁y”, “−2x₂y, “x₃y”, and “3y” exists, as the combination of terms obtained by the division that corresponds to the pattern expression stored in advance. When such a combination exists, the inconsistency determination unit 4 specifies the variable corresponding to “y” as the auxiliary variable.

The inconsistency determination unit 4 then determines that there is inconsistency regarding the auxiliary variable in the expression representing energy in the combinatorial optimization problem when the specified auxiliary variable is used in a term that is not included in the above combination. As mentioned above, it is common for an auxiliary variable not to be used outside of expression (7) in expression that encompasses expression (7), thus, such determination can be established.

When the above combination does not exist or when the specified auxiliary variable is not used in a term not included in the above combination, the inconsistency determination unit 4 determines that there is no inconsistency regarding the auxiliary variable in the expression representing energy in the combinatorial optimization problem.

In the second example embodiment, the presentation unit 5 displays on the display device the results of the determination as to whether or not there is inconsistency regarding an auxiliary variable in the formulated expression. When the auxiliary variable specified by the inconsistency determination unit 4 is used in a term that is not included in the above combination, that term may also be displayed.

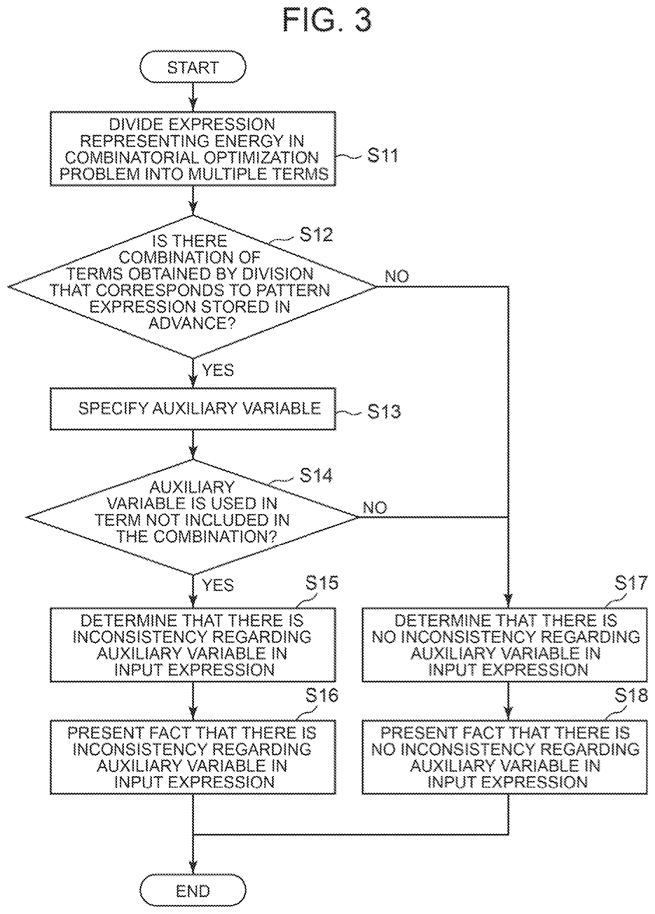

Next, the processing flow is described. FIG. 3 is a flowchart showing an example of the processing flow of the second example embodiment. Matters that have already been explained are omitted as appropriate.

When an expression representing energy in a combinatorial optimization problem is input to the input unit 2, the division unit 3 divides the expression into multiple terms (step S11). Step S11 is similar to step S1 in the first example embodiment (see FIG. 2).

Next, the inconsistency determination unit 4 determines whether or not there is a combination of terms obtained by the division by the division unit 3 that corresponds to the pattern expression stored in advance (step S12).

When such a combination exists (Yes in step S12), the inconsistency determination unit 4 specifies the auxiliary variable (step S13).

Next, the inconsistency determination unit 4 determines whether or not the auxiliary variable is used in a term not included in the combination (step S14). When the auxiliary variable is used in a term that is not included in the combination (Yes

in step S14), the inconsistency determination unit 4 determines that there is inconsistency regarding the auxiliary variable in the input expression (step S15). Then, the presentation unit 5 presents the fact that there is inconsistency regarding the auxiliary variable in the input expression (step S16). At this time, the presentation unit 5 may also present the term that is not included in the combination and in which the auxiliary variable is used.

When the auxiliary variable is not used in a term that is not included in the combination (No in step S14), the inconsistency determination unit 4 determines that there is no inconsistency regarding the auxiliary variable in the input expression (step S17). Then, the presentation unit 5 presents the fact that there is no inconsistency regarding the auxiliary variable in the input expression (step S18).

Also, when it is determined in step 12 that there is no combination of terms obtained by the division that corresponds to the pattern expression stored in advance (No in step S12), steps S17 and S18 are executed.

It is common for an auxiliary variable not to be used outside of the pattern expression in expression that encompasses the pattern expressions. In the present example embodiment, the inconsistency determination unit 4 specifies the auxiliary variable when the inconsistency determination unit 4 determines that there is a combination of the terms obtained by the division that corresponds to the pattern expression stored in advance. Then, when the auxiliary variable is used in a term that is not included in the combination, the inconsistency determination unit 4 determines that there is inconsistency regarding the auxiliary variable in the formulated expression. When the auxiliary variable is not used in a term that is not included in the combination, the inconsistency determination unit 4 determines that there is no inconsistency regarding the auxiliary variable in the formulated expression. Thus, according to the present embodiment, it is possible to determine whether or not there is inconsistency in the formulated expression.

### Example Embodiment 3

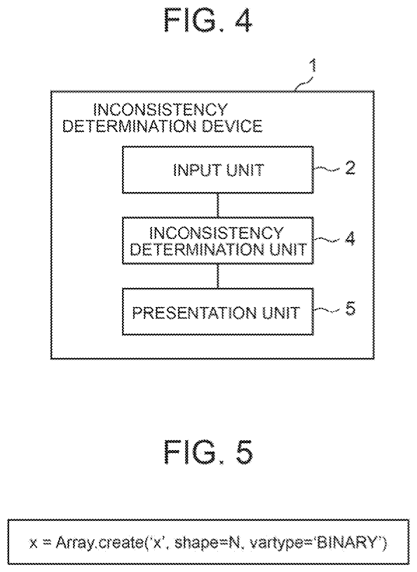

FIG. 4 is a block diagram showing an example configuration of an inconsistency determination device of the third example embodiment of the present invention. Elements similar to those of the first example embodiment and the second example embodiment are marked with the same signs as those shown in FIG. 1. The inconsistency determination device 1 of the third example embodiment includes an input unit 2, an inconsistency determination unit 4, and a presentation unit 5.

In the third example embodiment, a formulated expression (an expression representing energy in a combinatorial optimization problem) and a character string defining each variable representing state of spin are input to the input unit 2.

The input unit 2 may be realized by a data reading device that reads data (in the present example embodiment, the expression representing energy in the combinatorial optimization problem, and the character string defining each variable representing the state of spin) recorded on a data recording medium, such as an optical disk, for example. However, the input unit 2 is not limited to such a data reading device, but may also be an input device such as a keyboard for the user to input the expression and the character string.

Here, the character string defining each variable representing the state of spin may be described according to PyQUBO (registered trademark), for example. FIG. 5 shows an example of a character string defining each variable representing the state of spin, described according to PyQUBO. The character string exemplified in FIG. 5 is a character string defining N variables from x₁ to x_{N} as variables representing the state of spin. However, the description style of the character string defining each variable representing the state of spin is not limited to the description style according to PyQUBO.

The inconsistency determination unit 4 takes in, via the input unit 2, the formulated expression (the expression representing energy in the combinatorial optimization problem) and the character string defining each variable representing the state of spin. The inconsistency determination unit 4 then specifies each variable defined in the character string (each variable representing the state of spin).

Then, the inconsistency determination unit 4 determines whether or not there is a variable that is not used in the formulated expression among each variable defined in the character string. When there is a variable that is not used in the formulated expression among each variable defined in the character string, the inconsistency determination unit 4 determines that there is inconsistency in the formulated expression in that there is a variable that is not used in the formulated expression even though the variable is defined. When there is no variable that is not used in the formulated expression among the variables defined in the character string (in other words, when all variables defined in the character string are used in the formulated expression), the inconsistency determination unit 4 determines that there is no inconsistency in the formulated expression.

The presentation unit 5 displays the determination result by the inconsistency determination unit 4, for example, on a display device (not shown in FIG. 4) provided by the inconsistency determination device 1. For example, when it is determined that there is inconsistency in the formulated expression in which a variable is not used in the formulated expression even though the variable is defined, the presentation unit 5 displays information to that effect on the display device. At this time, the presentation unit 5 may also display the variable that is not used in the formulated expression even though the variable is defined. When it is determined that there is no inconsistency in the formulated expression, the presentation unit displays information to that effect on the display device.

The inconsistency determination unit 4 and the presentation unit 5 are realized, for example, by a CPU of a computer operating according to an inconsistency determination program. In this case, the CPU may read the inconsistency determination program from a program storage medium such as a program storage device of the computer, and operate as the inconsistency determination unit 4 and the presentation unit 5.

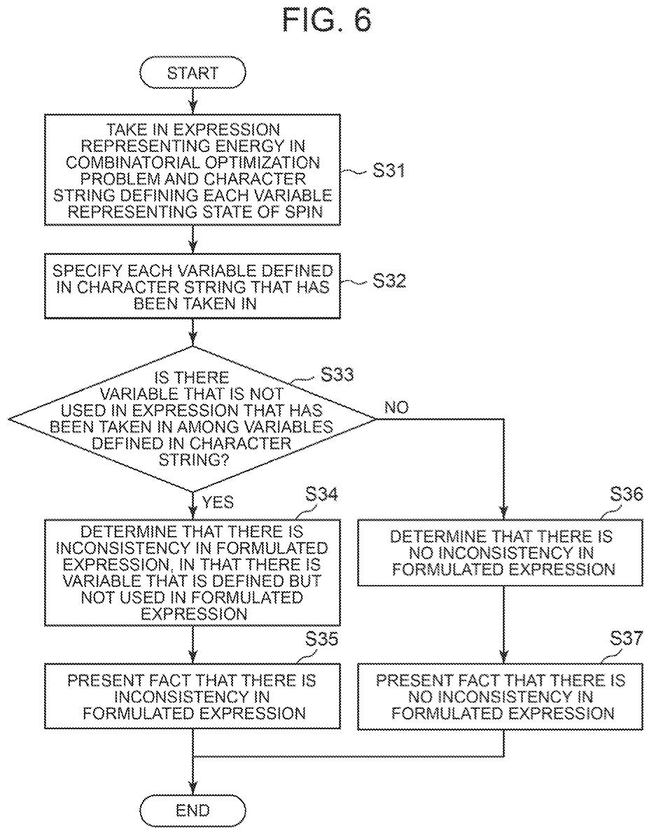

Next, the processing flow is described. FIG. 6 is a flowchart showing an example of the processing flow of the third example embodiment. Matters that have already been explained are omitted as appropriate.

The inconsistency determination unit 4 takes in, via input unit 2, an expression representing energy in a combinatorial optimization problem and a character string defining each variable representing state of spin (step S31). In this example, the inconsistency determination unit 4 takes in the character string shown in FIG. 5.

Next to step S31, the inconsistency determination unit 4 specifies each variable defined in the character string that has been taken in (step S32). In this example, the inconsistency determination unit 4 specifies the N variables of x₁, x₂, x₃, . . . , x_{N} defined in the character string shown in FIG. 5.

Next, the inconsistency determination unit 4 determines whether or not there is a variable that is not used in the expression that has been taken in among the variables (in this example, x₁, x₂, x₃, . . . , x_{N}) defined in the character string (step S33).

When there is a variable that is not used in the expression that has been taken in among the variables defined in the character string that has been taken in (Yes in step S33), the inconsistency determination unit 4 determines that there is inconsistency in the formulated expression, in that there is a variable that is defined but not used in the formulated expression (step S34). The presentation unit 5 then presents the fact that there is inconsistency in the formulated expression (step S35). At this time, the presentation unit 5 may also present the variable that is not used in the formulated expression even though the variable is defined.

When each variable defined in the character string that has been taken in is all used in the expression that has been taken in (No in step S33), the inconsistency determination unit 4 determines that there is no inconsistency in the formulated expression (step S36). The presentation unit 5 then presents the fact that there is no inconsistency in the formulated expression (step S37).

It is common for defined variables (variables that represent states of spins) to be used in the formulated expression. Then, in the present example embodiment, when any of the defined variables are not used in the formulated expression, it is determined that there is inconsistency in the formulated expression, and when all the defined variables are used in the formulated expression, it is determined that there is no inconsistency in the formulated expression. Thus, according to the present example embodiment, it is possible to determine whether or not there is inconsistency in the formulated expression.

In each of the above example embodiments, the case where the formulated expression (representing energy in a combinatorial optimization problem) is converted into an energy function of QUBO is exemplified. In this case, the variable representing the state of spin takes the value of 1 or 0. The invention may also be applied to the case where the formulated expression is converted into the energy function of the Ising model. In this case, the variable representing the state of spin takes the value of 1 or −1.

In addition, the energy function of QUBO and the energy function of the Ising model are mutually convertible. Therefore, the formulated expression in which there is no inconsistency may be converted to the energy function of QUBO, and then the energy function may be converted to energy function of the Ising model.

As already mentioned, “1” in QUBO and “1” in the Ising model can be referred to as the first value. “0” in QUBO and “−1” in the Ising model can be referred to as the second value.

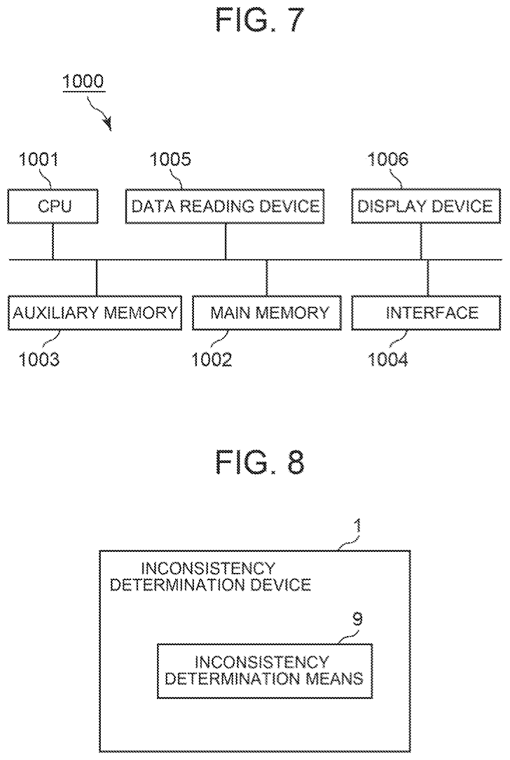

FIG. 7 is a schematic block diagram showing an example of computer configuration related to the inconsistency determination device of each example embodiment of the present invention. The computer 1000 includes a CPU 1001, a main memory 1002, an auxiliary memory 1003, an interface 1004, a data reading device 1005, and a display device 1006.

The inconsistency determination device 1 of each example embodiment of the present invention is realized by a computer 1000. The operation of the inconsistency determination device 1 is stored in the auxiliary memory 1003 in the form of an inconsistency determination program. The CPU 1001 reads the inconsistency determination program from the auxiliary memory 1003 and expands it in the main memory 1002, and executes the process described in each of the above example embodiments according to the inconsistency determination program.

The auxiliary memory 1003 is an example of a non-transitory tangible medium. Other examples of non-transitory tangible media include magnetic disks connected via interface 1004, magneto-optical disks, CD-ROM (Compact Disk Read Only Memory), DVD-ROM (Digital Versatile Disk Read Only Memory), semiconductor memory, etc. When the program is delivered to the computer 1000 through a communication line, the computer 1000 may expand the program in the main memory 1002 and execute the process described in each of the above example embodiments according to the program.

Some or all of the components may be realized by general-purpose or dedicated circuitry, processor, or a combination of these. These may comprise a single chip or multiple chips connected via a bus. Some or all of the components may be realized by a combination of the above-mentioned circuitry, etc. and a program.

When some or all of components is realized by multiple information processing devices, circuits, etc., the multiple information processing devices, circuits, etc. may be centrally located or distributed. For example, the information processing devices and circuits may be realized as a client-and-server system, a cloud computing system, etc., each of which is connected via a communication network.

Next, an overview of the present invention is described. FIG. 8 is a block diagram showing an overview of the inconsistency determination device of the present invention. The inconsistency determination device 1 of the present invention includes inconsistency determination means 9.

The inconsistency determination means 9 (e.g., the inconsistency determination unit 4) determines whether or not there is inconsistency in an expression, which is to be converted into an energy function of a model representing states of individual spins by a first value or a second value, representing energy in a combinatorial optimization problem.

The above example embodiments of the present invention can be described as, but not limited to, the following supplementary notes.

### Supplementary Note 1

An inconsistency determination device comprising:
inconsistency determination means for determining whether or not there is inconsistency in an expression, which is to be converted into an energy function of a model representing states of individual spins by a first value or a second value, representing energy in a combinatorial optimization problem.

### Supplementary Note 2

The inconsistency determination device according to supplementary note 1, further comprising:
division means for dividing the expression representing the energy into multiple terms;
wherein the inconsistency determination means
extracts two or more constraint terms each of which is a term representing a constraint, from the multiple terms; and
determines that there is inconsistency in the expression representing the energy, when there is inconsistency between the constraints represented by the extracted two or more constraint terms.

### Supplementary Note 3

The inconsistency determination device according to supplementary note 2,
wherein the constraint represented by a constraint terms is represented by an expression, and
wherein when substituting an expression representing a constraint into another expression representing a constraint results in inconsistency, the inconsistency determination means determines that there is inconsistency between the constraint corresponding to the substituted expression and the constraint corresponding to the expression accepting substitution.

### Supplementary Note 4

The inconsistency determination device according to supplementary note 1, further comprising:
division means for dividing the expression representing the energy into multiple terms;
wherein the inconsistency determination means
stores an expression with an auxiliary variable for lowering order of variables representing the states of spins to the second order, in advance;
determines whether or not there is a combination of terms obtained by division that corresponds to the expression stored in advance;
specifies the auxiliary variable when there is the combination; and
determines that there is inconsistency in the expression representing the energy, when the auxiliary variable is used in a term that is not included in the combination.

### Supplementary Note 5

The inconsistency determination device according to supplementary note 1,
wherein the inconsistency determination means
takes in the expression representing the energy and a character string defining each variable representing the states of spins; and
determines that there is inconsistency in the expression representing the energy, when there is a variable that is not used in the expression representing the energy among each variable defined in the character string.

### Supplementary Note 6

An inconsistency determination method, implemented by a computer, comprising:
determining whether or not there is inconsistency in an expression, which is to be converted into an energy function of a model representing states of individual spins by a first value or a second value, representing energy in a combinatorial optimization problem.

### Supplementary Note 7

The inconsistency determination method according to supplementary note 6,
wherein the computer
divides the expression representing the energy into multiple terms;
extracts two or more constraint terms each of which is a term representing a constraint, from the multiple terms; and
determines that there is inconsistency in the expression representing the energy, when there is inconsistency between the constraints represented by the extracted two or more constraint terms.

### Supplementary Note 8

The inconsistency determination method according to supplementary note 6,
wherein the computer
divides the expression representing the energy into multiple terms;
stores an expression with an auxiliary variable for lowering order of variables representing the states of spins to the second order, in advance;
determines whether or not there is a combination of terms obtained by division that corresponds to the expression stored in advance;
specifies the auxiliary variable when there is the combination; and
determines that there is inconsistency in the expression representing the energy, when the auxiliary variable is used in a term that is not included in the combination.

### Supplementary Note 9

The inconsistency determination method according to supplementary note 6,
wherein the computer
takes in the expression representing the energy and a character string defining each variable representing the states of spins; and
determines that there is inconsistency in the expression representing the energy, when there is a variable that is not used in the expression representing the energy among each variable defined in the character string.

### Supplementary Note 10

A computer-readable recording medium in which an inconsistency determination program is recorded, wherein the inconsistency determination program causes a computer to execute:
an inconsistency determination process of determining whether or not there is inconsistency in an expression, which is to be converted into an energy function of a model representing states of individual spins by a first value or a second value representing energy in a combinatorial optimization problem.

### Supplementary Note 11

The computer-readable recording medium in which the inconsistency determination program is recorded, according to supplementary note10,
wherein the inconsistency determination program causes the computer to execute:
a division process of dividing the expression representing the energy into multiple terms; and
wherein, in the inconsistency determination process, the inconsistency determination program causes the computer to execute:
extracting two or more constraint terms each of which is a term representing a constraint, from the multiple terms; and
determining that there is inconsistency in the expression representing the energy, when there is inconsistency between the constraints represented by the extracted two or more constraint terms.

### Supplementary Note 12

The computer-readable recording medium in which the inconsistency determination program is recorded, according to supplementary note10,
wherein the computer stores an expression with an auxiliary variable for lowering order of variables representing the states of spins to the second order, in advance,
wherein the inconsistency determination program causes the computer to execute:
a division process of dividing the expression representing the energy into multiple terms; and
wherein, in the inconsistency determination process, the inconsistency determination program causes the computer to execute:
determining whether or not there is a combination of terms obtained by division that corresponds to the expression stored in the computer in advance;
specifying the auxiliary variable when there is the combination; and
determining that there is inconsistency in the expression representing the energy, when the auxiliary variable is used in a term that is not included in the combination.

### Supplementary Note 13

The computer-readable recording medium in which the inconsistency determination program is recorded, according to supplementary note 10,
wherein, in the inconsistency determination process, the inconsistency determination program causes the computer to execute:
taking in the expression representing the energy and a character string defining each variable representing the states of spins; and
determining that there is inconsistency in the expression representing the energy, when there is a variable that is not used in the expression representing the energy among each variable defined in the character string.

Although the present invention has been described above with reference to example embodiments, the present invention is not limited to the above example embodiments. Various changes can be made to the configuration and details of the present invention that can be understood by those skilled in the art within the scope of the present invention.

### INDUSTRIAL APPLICABILITY

The present invention is suitably applied to an inconsistency determination device that determines whether or not there is inconsistency in the expression representing energy in a combinatorial optimization problem.

### REFERENCE SIGNS LIST

1 Inconsistency determination device
2 Input unit
3 Division unit
4 Inconsistency determination unit
5 Presentation unit

What is claimed is:

1. An inconsistency determination device comprising:
a memory configured to store instructions; and
a processor configured to execute the instructions to:
determine whether or not there is inconsistency in an expression, which is to be converted into an energy function of a model representing states of individual spins by a first value or a second value, representing energy in a combinatorial optimization problem.

2. The inconsistency determination device according to claim 1,
wherein the processor divides the expression representing the energy into multiple terms;
wherein the processor
extracts two or more constraint terms each of which is a term representing a constraint, from the multiple terms; and
determines that there is inconsistency in the expression representing the energy, when there is inconsistency between the constraints represented by the extracted two or more constraint terms.

3. The inconsistency determination device according to claim 2,
wherein the constraint represented by a constraint terms is represented by an expression, and
wherein when substituting an expression representing a constraint into another expression representing a constraint results in inconsistency, the processor determines that there is inconsistency between the constraint corresponding to the substituted expression and the constraint corresponding to the expression accepting substitution.

4. The inconsistency determination device according to claim 1,
wherein the processor divides the expression representing the energy into multiple terms;
wherein the processor
stores an expression with an auxiliary variable for lowering order of variables representing the states of spins to the second order, in advance;
determines whether or not there is a combination of terms obtained by division that corresponds to the expression stored in advance;
specifies the auxiliary variable when there is the combination; and
determines that there is inconsistency in the expression representing the energy, when the auxiliary variable is used in a term that is not included in the combination.

5. The inconsistency determination device according to claim 1,
wherein the processor
takes in the expression representing the energy and a character string defining each variable representing the states of spins; and
determines that there is inconsistency in the expression representing the energy, when there is a variable that is not used in the expression representing the energy among each variable defined in the character string.

6. An inconsistency determination method, implemented by a computer, comprising:
determining whether or not there is inconsistency in an expression, which is to be converted into an energy function of a model representing states of individual spins by a first value or a second value, representing energy in a combinatorial optimization problem.

7. The inconsistency determination method according to claim 6,
wherein the computer
divides the expression representing the energy into multiple terms;
extracts two or more constraint terms each of which is a term representing a constraint, from the multiple terms; and
determines that there is inconsistency in the expression representing the energy, when there is inconsistency between the constraints represented by the extracted two or more constraint terms.

8. The inconsistency determination method according to claim 6,
wherein the computer
divides the expression representing the energy into multiple terms;
stores an expression with an auxiliary variable for lowering order of variables representing the states of spins to the second order, in advance;
determines whether or not there is a combination of terms obtained by division that corresponds to the expression stored in advance;
specifies the auxiliary variable when there is the combination; and
determines that there is inconsistency in the expression representing the energy, when the auxiliary variable is used in a term that is not included in the combination.

9. The inconsistency determination method according to claim 6,
wherein the computer
takes in the expression representing the energy and a character string defining each variable representing the states of spins; and
determines that there is inconsistency in the expression representing the energy, when there is a variable that is not used in the expression representing the energy among each variable defined in the character string.

10. A non-transitory computer-readable recording medium in which an inconsistency determination program is recorded, wherein the inconsistency determination program causes a computer to execute:
an inconsistency determination process of determining whether or not there is inconsistency in an expression, which is to be converted into an energy function of a model representing states of individual spins by a first value or a second value, representing energy in a combinatorial optimization problem.

11. The non-transitory computer-readable recording medium in which the inconsistency determination program is recorded, according to claim 10,
wherein the inconsistency determination program causes the computer to execute:
a division process of dividing the expression representing the energy into multiple terms; and
wherein, in the inconsistency determination process, the inconsistency determination program causes the computer to execute:
extracting two or more constraint terms each of which is a term representing a constraint, from the multiple terms; and
determining that there is inconsistency in the expression representing the energy, when there is inconsistency between the constraints represented by the extracted two or more constraint terms.

12. The non-transitory computer-readable recording medium in which the inconsistency determination program is recorded, according to claim 10,
wherein the computer stores an expression with an auxiliary variable for lowering order of variables representing the states of spins to the second order, in advance,
wherein the inconsistency determination program causes the computer to execute:
a division process of dividing the expression representing the energy into multiple terms; and
wherein, in the inconsistency determination process, the inconsistency determination program causes the computer to execute:
determining whether or not there is a combination of terms obtained by division that corresponds to the expression stored in the computer in advance;
specifying the auxiliary variable when there is the combination; and
determining that there is inconsistency in the expression representing the energy, when the auxiliary variable is used in a term that is not included in the combination.

13. The non-transitory computer-readable recording medium in which the inconsistency determination program is recorded, according to claim 10,
wherein, in the inconsistency determination process, the inconsistency determination program causes the computer to execute:
taking in the expression representing the energy and a character string defining each variable representing the states of spins; and
determining that there is inconsistency in the expression representing the energy, when there is a variable that is not used in the expression representing the energy among each variable defined in the character string.
